(19) United States
(12) Patent Application Publication
(10) Pub. No.: US 2015/0106497 A1
(43) Pub. Date: Apr. 16, 2015

(54) COMMUNICATION DESTINATION DETERMINATION APPARATUS, COMMUNICATION DESTINATION DETERMINATION METHOD, COMMUNICATION DESTINATION DETERMINATION PROGRAM, AND GAME SYSTEM

(71) Applicant: KONAMI DIGITAL ENTERTAINMENT CO., LTD., Tokyo (JP)

(72) Inventors: Hiromasa KANEKO, Tokyo (JP); Naoya KIHARA, Tokyo (JP); Takahiro YOSHIDA, Yokohama-shi (JP)

(73) Assignee: KONAMI DIGITAL ENTERTAINMENT CO., LTD., Tokyo (JP)

(21) Appl. No.: 14/576,662

(22) Filed: Dec. 19, 2014

Related U.S. Application Data
(63) Continuation-in-part of application No. PCT/JP2013/068130, filed on Jul. 2, 2013.

(30) Foreign Application Priority Data
Jul. 2, 2012 (JP) 2012-148921

(51) Int. Cl. H04L 12/24

(52) U.S. Cl. CPC H04L 41/0806; H04L 41/0893
USPC 709/223

(57) ABSTRACT

A communication destination determination apparatus includes an acquisitor and a communication destination determiner. The acquisitor may be configured to acquire measurement results of accessibility of communication between each of a plurality of user terminals associated with each other and each of a plurality of game managers configured to communicate with each of the plurality of user terminals. The communication destination determiner may be configured to determine, based on the measurement results acquired by the acquisitor, and among the plurality of game managers, a target game manager as a communication destination to which the plurality of user terminals are to communicate.

### CROSS-REFERENCE TO RELATED APPLICATION

This application is a continuation-in-part of International Application No. PCT/JP2013/068130, filed Jul. 2, 2013.

### BACKGROUND OF THE INVENTION

1. Field of the Invention

Embodiments of the invention generally relate to a communication destination determination apparatus, a communication destination determination method, a communication destination determination program, and a game system.

2. Description of the Related Art

When playing a game in a user terminal, a user terminal generally reads in a game program by installing the game program into the user terminal beforehand or by connecting a storage medium into which a game program is stored to the user terminal, hereinafter referred to as installing and the like, performs computation processing, and changes a screen displayed based on computation results. In contrast, a game system is proposed whereby a game is played via a network such as the Internet or the like, without installation or the like of a game program into the user terminal. For example, the user terminal is connected to a game manager via a network such as the Internet, and instruction information input from a user is transmitted to the game manager. The game manager performs a prescribed computation processing in accordance with the instruction information transmitted from the user terminal, and streams to the user terminal a screen that reflects the results in real time, based on the computation results. This enables the display of a screen based on the same as the conventional computation results and the playing of the game by the user, without installation or the like of a game program because the processing performed by the user terminal is only input and output.

When the above-described game system provides a multi-play game to a plurality of users playing simultaneously, the user terminals used by a plurality of users that are associated by matching processing are connected to the same game manager. Unless highly accessible communication is available, which depend upon the communication distance and communication bandwidth and the like between each of the user terminals and the game manager, it is not easy for the user to have an enjoyable game experience. It would have been desirable to have the users experience as pleasant communication condition as possible.

### SUMMARY

In one embodiment, a communication destination determination apparatus may include, but is not limited to, an acquisitor and a communication destination determiner. The acquisitor may be configured to acquire measurement results of accessibility of communication between each of a plurality of user terminals associated with each other and each of a plurality of game managers configured to communicate with each of the plurality of user terminals. The communication destination determiner may be configured to determine, based on the measurement results acquired by the acquisitor, and among the plurality of game managers, a target game manager as a communication destination to which the plurality of user terminals are to communicate.

### BRIEF DESCRIPTION OF THE DRAWINGS

The above features and advantages of the embodiments of the present invention will be more apparent from the following descriptions of certain illustrative embodiments taken in conjunction with the accompanying drawings, in which:

FIG. 1 is a block diagram of configurations of a game system in first and second embodiments of the invention;

FIG. 2 is a map showing locations of user terminals, game managers and communication destination determiners in the game system in the first and second embodiments of the invention;

FIG. 3 is a data table showing measurement results in the first and second embodiments of the invention;

FIG. 4 is an operation chart of the game system in the first and second embodiments of the invention; and

FIG. 5 is a block diagram of other configurations of a game system in a third embodiment of the invention.

### DETAILED DESCRIPTION OF THE EMBODIMENTS

Embodiments of the invention will be described herein. Those skilled in the art will recognize that many alternative embodiments can be accomplished using the teaching of the embodiments and that the invention is not limited to the embodiments illustrated for explanatory purpose.

In one embodiment, a communication destination determination apparatus may include, but is not limited to, an acquisitor and a communication destination determiner. The acquisitor may be configured to acquire measurement results of accessibility of communication between each of a plurality of user terminals associated with each other and each of a plurality of game managers configured to communicate with each of the plurality of user terminals. The communication destination determiner may be configured to determine, based on the measurement results acquired by the acquisitor, and among the plurality of game managers, a target game manager as a communication destination to which the plurality of user terminals are to communicate. The acquisitor and the communication destination determiner are implemented by one or more processors.

In some cases, the communication destination determiner may be configured to calculate respective sums of the measurement results, for respective game managers, each sum being calculated from the measurement results of accessibility of communication between the plurality of user terminals and a respective one of the plurality of game managers. The communication destination determiner may be configured to compare the respective sums with each other. The communication destination determiner may be configured to determine, based on a result of comparison among the respective sums, the target game manager as a communication destination to which the plurality of user terminals are to communicate. In some cases, the communication destination determiner may be configured to weight the measurement results of accessibility of communication between each of the plurality of user terminals and each of the plurality of game managers. The communication destination determiner may be configured to calculate respective weighted sums of the weighted measurement results, for respective game managers, each weighted sum being calculated from the weighted measurement results of accessibility of communication between the plurality of user terminals and a respective one of the plurality of game managers. The communication destination determiner may be configured to compare the respective weighted sums with each other. The communication destination determiner may be configured to determine, based on a result of comparison among the respective weighted sums, the target game manager as a communication destination to which the plurality of user terminals are to communicate.

In some cases, the acquisitor may be configured to acquire, as the measurement result, a period of time from transmission by the user terminal of a packet to the game manager until the user terminal receives a response from the game manager. The communication destination determiner may be configured to calculate respective sums of the periods of time, for respective game managers, each sum being calculated from the periods of time from transmissions by the plurality of user terminals of packets to a respective one of the plurality of game managers until each of the plurality of user terminals receives a response from the respective one of the plurality of game managers. The communication destination determiner may be configured to compare the respective sums with each other. The communication destination determiner may be configured to determine, based on a result of comparison among the respective sums, the target game manager as a communication destination having a smallest sum among the plurality of game managers having the respective sums.

In some cases, the acquisitor may be configured to acquire, as the measurement result, a period of time from transmission by the user terminal of a packet to the game manager until the user terminal receives a response from the game manager. The communication destination determiner may be configured to weight each of the periods of time from transmissions by each of the plurality of user terminals of packets to each of the plurality of game managers until the each user terminal receives a response from the each game manager. The communication destination determiner may be configured to calculate respective weighted sums of the weighted periods of time, for respective game managers, each sum being calculated from the weighted periods of time from transmissions by the plurality of user terminals of packets to a respective one of the plurality of game managers until each of the plurality of user terminals receives a response from the respective one of the plurality of game managers. The communication destination determiner may be configured to compare the respective weighted sums with each other. The communication destination determiner may be configured to determine, based on a result of comparison among the respective sums, the target game manager as a communication destination having a smallest weighted sum among the plurality of game managers having the respective weighted sums.

In some cases, the communication destination determiner may be configured to weight each of the periods of time by squaring the each period of time.

In some cases, the communication destination determiner may be configured to calculate respective determination reference values for respective ones of the plurality of game managers, from the measurement results acquired by the acquisitor. The communication destination determiner may be configured to determine, among the plurality of game managers, the target game manager as a communication destination with reference to the respective determination reference values.

In another embodiment, a communication destination determination system may include, but is not limited to, a plurality of user terminals associated with each other; a plurality of game managers configured to communicate with each of the plurality of user terminals; a measurer and a communication destination determiner. The measurer may be configured to measure an accessibility of communication between each of the plurality of user terminals and each of the plurality of game managers. The communication destination determiner may be configured to determine, based on the accessibility of communication measured by the measurer, and among the plurality of game managers, a target game manager as a communication destination to which the plurality of user terminals are to communicate. The game managers, the measurer, and the communication destination determiner are implemented by one or more processors.

In still another embodiment, a communication destination determination method may include, but is not limited to, an acquiring process, and a determining process. The acquiring process is to acquire measurement results of accessibility of communication between each of a plurality of user terminals associated with each other and each of a plurality of game managers configured to communicate with each of the plurality of user terminals. The determining process is to determine, based on the measurement results acquired, and among the plurality of game managers, a target game manager as a communication destination to which the plurality of user terminals are to communicate. The acquiring process and the determining process are implemented by one or more processors.

In yet another embodiment, a non-transitory computer readable storage medium stores a computer program to be executed by a computer to perform communication destination determination method. The program may include, but is not limited to, an acquiring code and a determining code. The acquiring code is to acquire measurement results of accessibility of communication between each of a plurality of user terminals associated with each other and each of a plurality of game managers configured to communicate with each of the plurality of user terminals. The determining code is to determine, based on the measurement results acquired, and among the plurality of game managers, a target game manager as a communication destination to which the plurality of user terminals are to communicate.

In an additional embodiment, a communication destination determination apparatus may include, but is not limited to, a communication destination determiner. The communication destination determiner may be configured to calculate respective determination reference values, for respective ones of a plurality of game managers configured to communicate with each of a plurality of user terminals associated with each other, from measurement results of accessibility of communication between each of the plurality of user terminals and each of the plurality of game managers. The communication destination determiner may be configured to determine, among the plurality of game managers, a target game manager as a communication destination with reference to the respective determination reference values. The communication destination determiner is implemented by one or more processors.

In a still additional embodiment, a communication destination determination method may include, but is not limited to, a calculating process and a determining process. The calculating process is to calculate respective determination reference values, for respective ones of a plurality of game managers configured to communicate with each of a plurality of user terminals associated with each other, from measurement results of accessibility of communication between each of the plurality of user terminals and each of the plurality of game managers. The determining process is to determine, among the plurality of game managers, a target game manager as a communication destination with reference to the respective determination reference values. The calculating process and the determining process are implemented by one or more processors.

In yet an additional embodiment, a non-transitory computer readable storage medium stores a computer program to be executed by a computer to perform communication destination determination method. The program may include, but are not limited to, a calculating code and a determining code. The calculating code is to calculate respective determination reference values, for respective ones of a plurality of game managers configured to communicate with each of a plurality of user terminals associated with each other, from measurement results of accessibility of communication between each of the plurality of user terminals and each of the plurality of game managers. The determining code is to determine, among the plurality of game managers, a target game manager as a communication destination with reference to the respective determination reference values.

An embodiment of the present invention will be described below, with references made to the drawings.

### First Embodiment

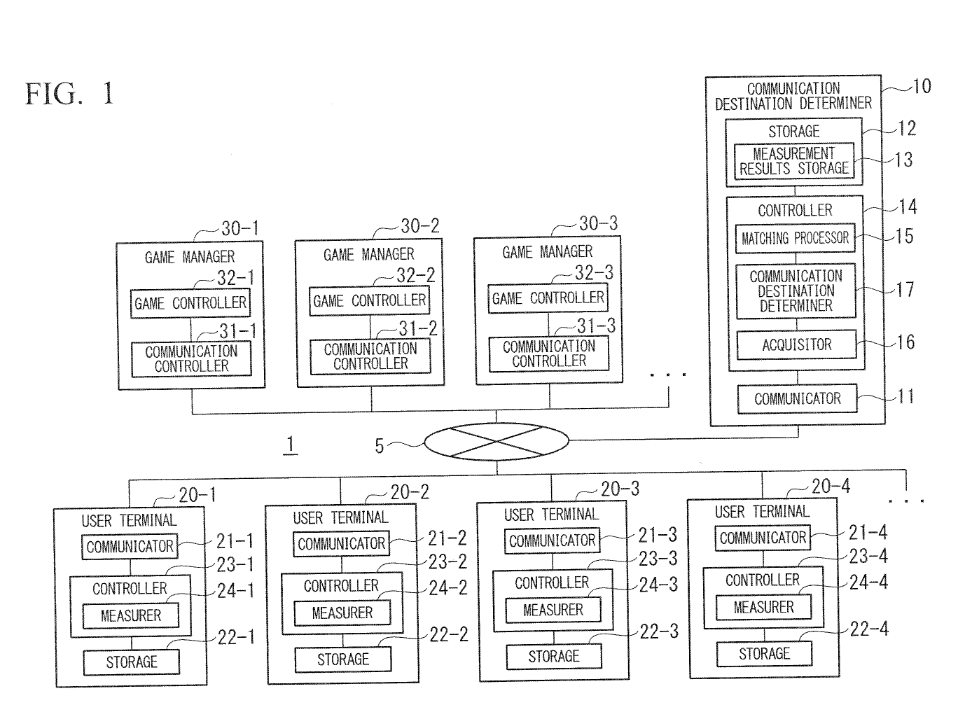

The first embodiment of the present invention will be described. FIG. 1 is a block diagram showing the configuration of a game system 1 according to the present embodiment. The game system 1 has computers, these being a communication destination determiner 10, a plurality of user terminals 20 (user terminal 20-1, user terminal 20-2, user terminal 20-3, user terminal 20-4, . . . ), and a plurality of game managers 30 (game manager 30-1, game manager 30-2, game manager 30-3, . . . ), and these computers being connected via a network 5. Because the plurality of user terminals 20 has a similar configuration, they will be described as the user terminal 20, omitting the suffixes -1 and -2 and the like when not particularly distinguishing therebetween. Because the plurality of game managers 30 has a similar configuration, they will be described as the game manager 30, omitting the suffixes -1 and -2 and the like when not particularly distinguishing therebetween. Although the drawing shows four user terminals 20 and three game managers 30, which will be described, an arbitrary number of user terminals 20 and game managers 30 may each be connected via the network 5.

The communication destination determiner 10 matches and associates a plurality of user terminals 20 simultaneously playing the same game and, of the plurality of game managers 30, determines which of the game managers 30 is the communication destination with which the plurality of associated user terminals 20 should communicate, based on the communication condition between the user terminal 20 and the game manager 30.

The user terminal 20 transmits to the communication destination determiner 10 a request for matching other users playing the same game. The communication destination determiner 10 performs user matching to associate a plurality of user terminals 20 playing the same game, and determines from among the plurality of game managers 30 the game manager 30 that is the communication destination. The user terminal 20, via the network 5, connects to and communicates with the game manager 30 that has been determined by the communication destination determiner 10 to be the communication destination.

The game manager 30 communicates in accordance with the connection from the user terminal 20 and provides a multi-play game service that can be played via the network 5.

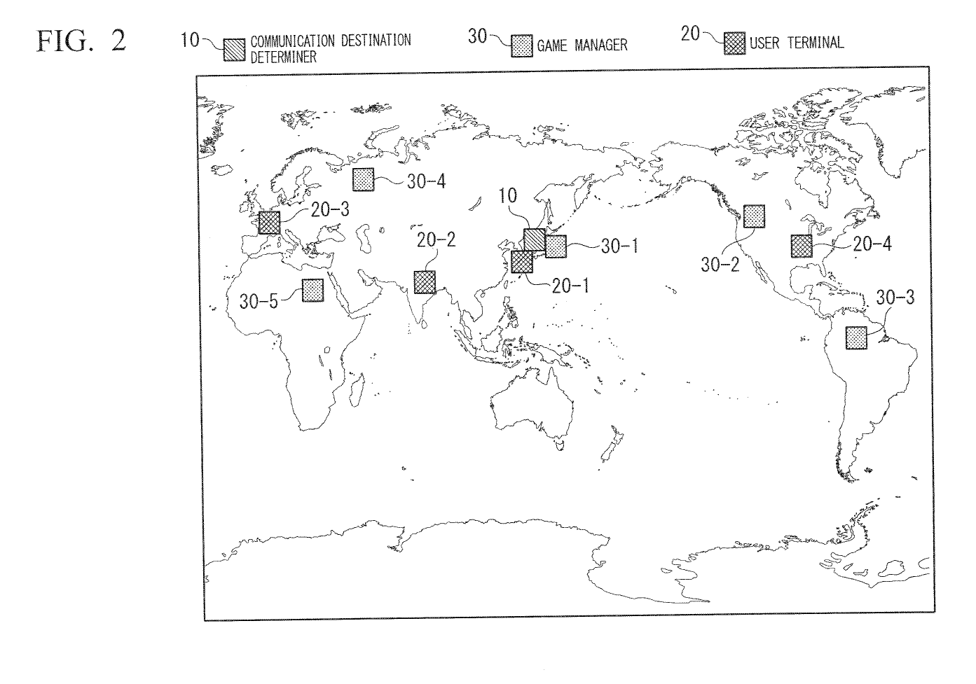

FIG. 2 shows an example of the locations of various computers of the game system 1 in the present embodiment. In this example, there is one communication destination determiner 10 in Japan. The communication destination determiner 10 is taken as having matched four user terminals 20, the user terminal 20-1 communicating from Japan, the user terminal 20-2 communicating from India, the user terminal 20-3 communicating from France, and the user terminal 20-4 communicating from the US. Five game managers 30 are taken as being installed, the game manager 30-1 installed in Japan, the game manager 30-2 installed in North America, the game manager 30-3 installed in South America, the game manager 30-4 installed in Eurasia (Europe), and the game manager 30-5 installed in Africa.

In this manner, in the present embodiment, game managers 30 providing a multi-play game via the network 5 are installed in a distributed manner at a plurality of locations. Of the plurality of game managers 30, the game manager 30 at a location enabling the most accessible communication for the matched user terminals 20 is determined and that game manager 30 is caused to provide the game service. This enables a more pleasant communication environment in a game played by a user than in the case of a game manager 30 installed in one location. The locations, number, and scale of the game managers 30 such as this can be established in accordance with the number of users to be connected to the game system 1, the type of games, and the like.

Referring again to FIG. 1, the network 5 is an information communication network configured by the Internet, a WAN (Wide Area Network), a LAN (Local Area Network), a dedicated line, or a combination thereof.

The communication destination determiner 10 has a communicator 11, a storage 12, and a controller 14.

The communicator 11 communicates with another computer via the network 5.

The storage 12 is configured using storage medium such as a RAM (random-access memory), a ROM (read-only memory), or a HD (hard-disk) drive or the like, or a combination thereof, and stores various information referenced by the communication destination determiner 10 when it operates. The storage 12 has a measurement results storage 13.

The measurement results storage 13 stores the results of measuring the accessibility of communication between a plurality of user terminals 20 associated by matching and the plurality of game managers 30 that can communicate with the plurality of user terminals 20. The accessibility of communication is a value that represents the speed and degree of communication performed by a user terminal 20 and a game manager 30. The greater is the accessibility of communication, the faster and more accessible is the communication, and the smaller is the accessibility of communication, the slower and less accessible is the communication.

The accessibility of communication can be, for example, a period of time from transmission by the user terminal 20 of a prescribed packet amount to the game manager 30 until it receives a response. The period of time is, for example, the amount of time (RTT: roundtrip time) from the transmitting of an echo request packet based on the ICMP to the game manager 30 by the user terminal 20 executing a ping program until the receiving of an echo reply packet from the game manager 30 in response thereto. In this case, the smaller is the value of the period of time, the greater is the accessibility of communication, and the larger is the value of the period of time, the smaller is the accessibility of communication.

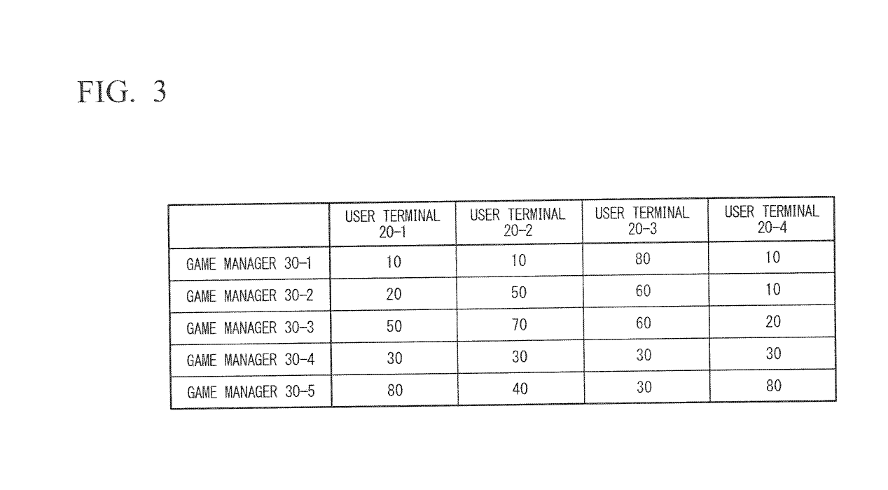

FIG. 3 shows an example of the measurement results data stored in the measurement results storage 13, this showing an example, for five game managers 30 and for four user terminals 20, the associated results of pinging to measure the period of times, shown in units of milliseconds. For example, the period of times indicated by the results of measurement by pinging with respect to the game manager 30-1 from the plurality of user terminals 20 are shown as 10 ms for the user terminal 20-1, 10 ms for the user terminal 20-2, 80 ms for the user terminal 20-3, and 10 ms for the user terminal 20-4.

Referring again to FIG. 1, the controller 14 has an information processor such as a CPU (central processing unit) that functions as the processing center of the communication destination determiner 10 and controls the various parts of the communication destination determiner 10. The controller 14 has a matching processor 15, an acquisitor 16, and a communication destination determiner 17.

The matching processor 15, in response to a matching request transmitted from the user terminal 20, performs matching that determines combinations of user terminals 20 playing the same game. This associates a plurality of user terminals 20.

The acquisitor 16 acquires the results of measuring the accessibility of communication between the plurality of user terminals 20 associated by the matching processor 15 and the plurality of game managers 30 that can communicate with each of the plurality of user terminals 20. For example, the acquisitor 16 transmits an accessibility of communication measurement request to a plurality of user terminals 20 associated by the matching processor 15, receives measurement results from the user terminals 20 in response to the transmitted measurement request, and stores the received measurement results in the measurement results storage 13. In this case, for example, the acquisitor 16 includes a list of IP addresses of a plurality of game managers 30 within the measurement request to be transmitted to the user terminals 20, and the user terminals 20 measure the communication accessibility with respect to each of the IP addresses indicated in the list included in the measurement request.

The communication destination determiner 17, based on the measurement results acquired by the acquisitor 16, determines from the plurality of game managers 30 the game manager 30 that is the communication destination of the associated plurality of user terminals 20. The communication destination determiner 17, based on the results of measuring, for each game manager 30, the accessibility of communication between that game manager 30 and the plurality of mutually associated user terminals 20, calculates a determination reference value corresponding to each of the plurality of game managers. The determination reference values are referenced and, from among the plurality of game managers 30, a game manager is determined to be the one with which the plurality of user terminals should communicate. For example, the communication destination determiner 17, for each of the plurality of game managers 30, calculates the sum of the measurement results between that game manager 30 and the plurality of associated user terminals 20 and, based on the results of comparing the calculated sums, determines the game manager 30 with which the plurality of associated user terminals 20 should communicate.

For example, the communication destination determiner 17 reads out the period of times acquired by the acquisitor 16 and stored in the measurement results storage 13 and, for each of the plurality of game managers 30, calculates the sum of the period of times between that game manager 30 and the plurality of user terminals 20. The communication destination determiner 17 determines as the game manager 30 that is the communication destination, with which the plurality of user terminals 20 should communicate the game manager 30 having the smallest calculated sum. In the example of FIG. 3, the sum of the times required with respect to the game manager 30-1 is 110 (10+10+80+10), the sum of the times required with respect to the game manager 30-2 is 140 (20+50+60+10), the sum of the times required with respect to the game manager 30-3 is 200 (50+70+60+20), the sum of the times required with respect to the game manager 30-4 is 120 (30+30+30+30), and the sum of the times required with respect to the game manager 30-5 is 230 (80+40+30+80). Of these, the one having the smallest sum is the game manager 30-1 with 110, and the game manager 30-1 is determined to be the game manager 30 with which the plurality of user terminals 20 should communicate.

A user terminal 20 is a computer used by a user, such as a PC (personal computer), a tablet PC, a smartphone, or a game machine or the like. In the present embodiment, the description is for a PC used as the user terminal 20. The user terminal 20 has an input device such as a keyboard, a mouse, or a touch panel or the like, and accepts input of instruction information from a user. The user terminal 20 may have a display that displays information such as text and images and a speaker or the like that outputs sound. The user terminal 20 has a communicator 21a storage 22, and a controller 23.

In this case, the user terminal 20 uses a game service provided by the game manager 30 connected via the network 5 and allows a user to play a game. In the present embodiment, the user terminal 20 first transmits a matching request to the communication destination determiner 10 based on instruction information input from a user. The user terminal 20 also measures and transmits to the communication destination determiner 10 the communication accessibility between it and a plurality of game managers 30 connected via the network 5. Of the plurality of game managers 30, connection is made to the game manager 30 determined by the communication destination determiner 10 to be the communication destination. When a game is started by the connected game manager 30, the user terminal 20 transmits instruction information to the game manager 30, receives from the game manager 30 a streamed screen reflecting the result of prescribed computation processing by the game manager 30 in accordance with transmitted instruction information, which screen it presents on a display. The instruction information transmitted to the game manager 30 by the user terminal 20 is, for example, information indicating operations in a game. This enables the user to play the game without installation or the like of a game program into the user terminal 20.

The communicator 21 communicates with the game manager 30 via the network 5.

The storage 22 stores various information referenced by the user terminal 20 when it operates. The storage 22 is configured by using a storage medium such as RAM, ROM, a HD drive or the like, or using a combination thereof.

The controller 23 is configured by, for example, a CPU, and controls various parts of the communication destination determiner 10. The controller 23 has a measurer 24.

The measurer 24 measures the communication accessibility between its own user terminal 20 and each of a plurality of game managers 30 connected via the network 5. For example, the measurer 24, by the above-described ping program, measures the required times for communication with each of a plurality of game managers 30, and then transmits the measurement results to the communication destination determiner 10 via the communicator 21.

The game manager 30 is a computer providing a user terminal 20 with a game service allowing the user terminal 20 to play a game via the network and has a communication controller 31 and a game controller 32.

The communication controller 31 is configured by, for example, a CPU, and controls communication between the game manager 30 and other computers. For example, the communication controller 31 receives a packet transmitted from a user terminal 20 by a ping program and transmits a response to the received packet. The communication controller 31 also, when it is determined by the communication destination determiner 10 as communication destination of the plurality of associated user terminals 20, causes the game controller 32 to execute game processing. The communication controller 31 buffers a movie generated by game controller 32 in response to each of a plurality of user terminals 20, performing encoding at a bit rate suitable for real-time movie streaming, and transmits the movie to the user terminal 20 in streaming format. Streaming is the successive transfer and playback of time sequence movie data as the data is being received. This enables a real-time display on the user terminal 20 of a movie that changes in accordance with instruction information.

The game controller 32 executes a game program performing computation of a game for an associated user terminal 20. The game program, based on instruction information transmitted by each of a plurality of associated user terminals 20, performs prescribed computation processing and generates a movie based on the calculation results thereof. The game provided by the game controller 32 is, for example, a sports game such a race game, an action game such as a fighting game, a shooting game such as FPS (First Person Shooter), a role-playing game, a puzzle game, or a simulation game, and is a multi-play game in which a plurality of user terminals 20 are allowed to play the same game simultaneously. The game controller 32 uses a GPU (graphic processing unit) of the game manager 30 to render the game screen and output to the communication controller 31a movie, which is a continuity of screen frames that change with time.

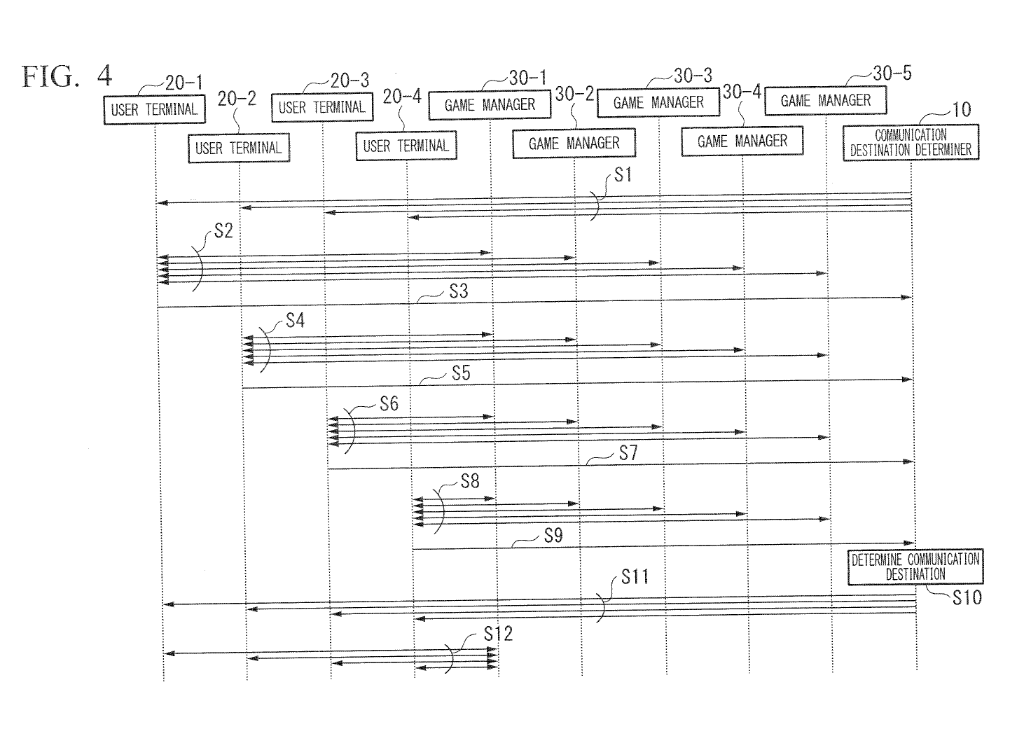

Next, referring to the drawings, an example of the operation of the game system 1 according to the present embodiment will be described. FIG. 4 shows an example of the operation of the game system 1 according to the present embodiment.

In this case, a matching request is made to the communication destination determiner 10 from the user terminal 20-1, the user terminal 20-2, the user terminal 20-3, and the user terminal 20-4, and the communication destination determiner 10 matches and associates the user terminals 20. The acquisitor 16 of the communication destination determiner 10 transmits a communication accessibility measurement request to the user terminal 20-1, the user terminal 20-2, the user terminal 20-3, and the user terminal 20-4 (step S1).

When the user terminal 20-1 receives the communication accessibility measurement request from the communication destination determiner 10, the measurer 24-1 thereof measures the communication accessibility with the game manager 30-1, the game manager 30-2, the game manager 30-3, the game manager 30-4, and the game manager 30-5 (step S2). The user terminal 20-1 transmits the communication accessibility measurement results to the communication destination determiner 10 (step S3). Upon receiving the measurement results transmitted from the user terminal 20-1, the acquisitor 16 of the communication destination determiner 10 stores the received measurement results into the measurement results storage 13.

In the same manner, when the user terminal 20-2 receives the communication accessibility measurement request from the communication destination determiner 10, the measurer 24-2 thereof measures the communication accessibility with the game manager 30-1, the game manager 30-2, the game manager 30-3, the game manager 30-4, and the game manager 30-5 (step S4). The user terminal 20-2 transmits the communication accessibility measurement results to the communication destination determiner 10 (step S5). Upon receiving the measurement results from the user terminal 20-2, the acquisitor 16 of the communication destination determiner 10 stores the received measurement results into the measurement results storage 13.

In the same manner, when the user terminal 20-3 receives the communication accessibility measurement request from the communication destination determiner 10, the measurer 24-3 thereof measures the communication accessibility with the game manager 30-1, the game manager 30-2, the game manager 30-3, the game manager 30-4, and the game manager 30-5 (step S6). The user terminal 20-3 transmits the communication accessibility measurement results to the communication destination determiner 10 (step S7). Upon receiving the measurement results from the user terminal 20-3, the acquisitor 16 of the communication destination determiner 10 stores the received measurement results into the measurement results storage 13.

In the same manner, when the user terminal 20-4 receives the communication accessibility measurement request from the communication destination determiner 10, the measurer 24-4 thereof measures the communication accessibility with the game manager 30-1, the game manager 30-2, the game manager 30-3, the game manager 30-4, and the game manager 30-5 (step S8). The user terminal 20-4 transmits the communication accessibility measurement results to the communication destination determiner 10 (step S9). Upon receiving the measurement results from the user terminal 20-4, the acquisitor 16 of the communication destination determiner 10 stores the received measurement results into the measurement results storage 13.

The communication destination determiner 17 of the communication destination determiner 10, based on the measurement results of each user terminal 20 stored in the measurement results storage 13, determines the game manager 30 that is the communication destination with which the user terminals 20 should communicate (step S10). In the present embodiment, this determination is made, as described above, by the communication destination determiner 17 referencing the measurement results storage 13 and calculating the sum of the communication accessibility measured at each of the user terminals 20 for each of the game managers 30, and taking the game manager 30 having the smallest sum to be the communication destination with which each user terminals 20 are to communicate. In this case, the game manager 30-1 is determined to be the communication destination. The communication destination determiner 17 transmits, via the communicator 11, identification information indicating the determined communication destination to the user terminal 20-1, the user terminal 20-2, the user terminal 20-3, and the user terminal 20-4 (step S11). The identification information indicating the communication destination is, for example, the IP address or port number or the like of the game manager 30. The user terminal 20-1, the user terminal 20-2, the user terminal 20-3, and the user terminal 20-4 connect to and communicate with the game manager 30-1 indicated by the identification information transmitted from the communication destination determiner 10 (step S12) and begin a multi-game game.

Although the above has been a description, referring FIG. 4, of an example in which the communication destination determiner 10 transmits a communication accessibility measurement request to each user terminal 20 and receives communication accessibility measurement results from each user terminal 20, a configuration may be adopted in which the communication destination determiner 10 transmits a communication accessibility measurement request to each game manager 30 and receives the communication accessibility measurement results from each game manager 30.

As described above, according to the present embodiment, game managers 30 are installed in a plurality of locations and, based on the communication accessibility of each of a plurality of associated user terminals 20, the plurality of user terminals 20 are made to communicate with the game manager 30 of the plurality of game managers 30 with which the communication accessibility is greatest. This enables selection of a game manager 30 with which highly accessible communication is possible, compared to the case in which a game manager 30 is installed in only one location and there is no opportunity for selection by the user terminals 20, thereby communicating with one game manager 30 to play a game. This enables associated user terminals 20 to play the game smoothly.

### Second Embodiment

A second embodiment of the present invention will be described. Although, the game system 1 in the present embodiment has a similar configuration as the game system 1 in the first embodiment, the method of determination of the communication destination by the communication destination determiner 17 of the communication destination determiner 10 is different.

In the first embodiment, the communication destination determiner 17, for each of a plurality of game managers 30, calculates the sum of the measurement results between that game manager 30 and a plurality of associated user terminals 20 and, based on the results of comparing the calculated sums, determines the game manager 30 with which the plurality of associated user terminals 20 should communicate. In this case, for example as shown in FIG. 3 and described above, the game manager 30-1 having the sum of 110, which is the smallest, is determined to be the game manager 30 that is the communication destination.

Although this enables a determination of a game manager 30 capable of communicating at higher accessibility with a relatively large number of user terminals 20, compared with other game managers 30, whereas the required time for the user terminal 20-1, the user terminal 20-2, and the user terminal 20-4 is 10, the required time for the user terminal 20-3 is 80. In this case, a variation occurs between the user terminals 20 in the time from the input of instruction information to the user terminal 20 until the computation results are displayed. Given this, particularly in a game in which the game progress is influenced by the timing of input of instruction information from a user terminal 20 or by real-time performance, there could be cases in which smooth progress through the game is not possible.

For example, in response to the action of a character corresponding to the user terminal 20-1, which has a small required time, when causing action of a character corresponding to the user terminal 20-3, which has a large required time, because of the relative delay of the action of the character corresponding to the user terminal 20-3, the user of the user terminal 20-3 might sense an unfairness. Also, in a scene in which a prescribed effect is to be obtained by a plurality of user terminals 20 inputting prescribed instruction information simultaneously, it might be difficult to adjust the timing of inputs of the prescribed instruction information from a plurality of user terminals 20 so as to be simultaneous. In such cases, of the plurality of user terminals 20, it is desirable that a determination be made of a game manager 30 for which there does not exist a user terminal 20 having a particularly small communication accessibility.

Given this, the communication destination determiner 17 of the present embodiment calculates a weighted sum of the measurement results for each of a plurality of game managers 30 with each of a plurality of user terminals 20 and, based on the results of comparing the calculated sums, determines the game manager 30 with which the plurality of user terminals 20 should communicate. Specifically, for example, the communication destination determiner 17, for each of a plurality of game managers 30, calculates the sum of the squared values of the required time for each of the plurality of user terminals 20 with respect to that game manager 30, and determines the game manager 30 having the smallest calculated sum as the game manager 30 with which the plurality of user terminals 20 should communicate.

If this is done, in the example shown in FIG. 3, the sum of the squared values of the required times with respect to the game manager 30-1 is 6700 (100+100+6400+100), the sum of the squared values of the required times with respect to the game manager 30-2 is 6600 (400+2500+3600+100), the sum of the squared values of the required times with respect to the game manager 30-3 is 11400 (2500+4900+3600+400), the sum of the squared values of the required times with respect to the game manager 30-4 is 3600 (900+900+900+900), and the sum of the squared values of the required times with respect to the game manager 30-5 is 15300 (6400+1600+900+6400). Of these, because the smallest is the 3600 of the game manager 30-4, the game manager 30-4 is determined to be the game manager 30 with which the plurality of user terminals 20 should communicate. This enables determination of the game manager 30 for which there does not exist a user terminal 20 among the plurality of user terminals 20 having a particularly small communication accessibility, and avoids progress through a game with a particular user feeling unfairness.

In addition to this method of determining the communication destination, it is also possible, for example, to determine as the communication destination the game manager 30 that has the smallest maximum value of required time with respect a plurality of user terminals 20 for that game manager 30. Alternatively, the game manager 30 having the smallest variation in required time can be determined to be the communication destination. For example, by determining, in accordance with the frame rate of the game results movie, the game manager 30 that makes the difference in frame rates among the user terminals 20 as possible small as the communication destination, it is possible to have a plurality of users play a game with the greatest possible fairness. Alternatively, the communication destination can be determined based on the required time with the maximum frequency of occurrence, or the communication destination can be determined based on the standard deviation of the required time. Alternatively, the communication destination can be determined based on a combination of such calculation results.

### Third Embodiment

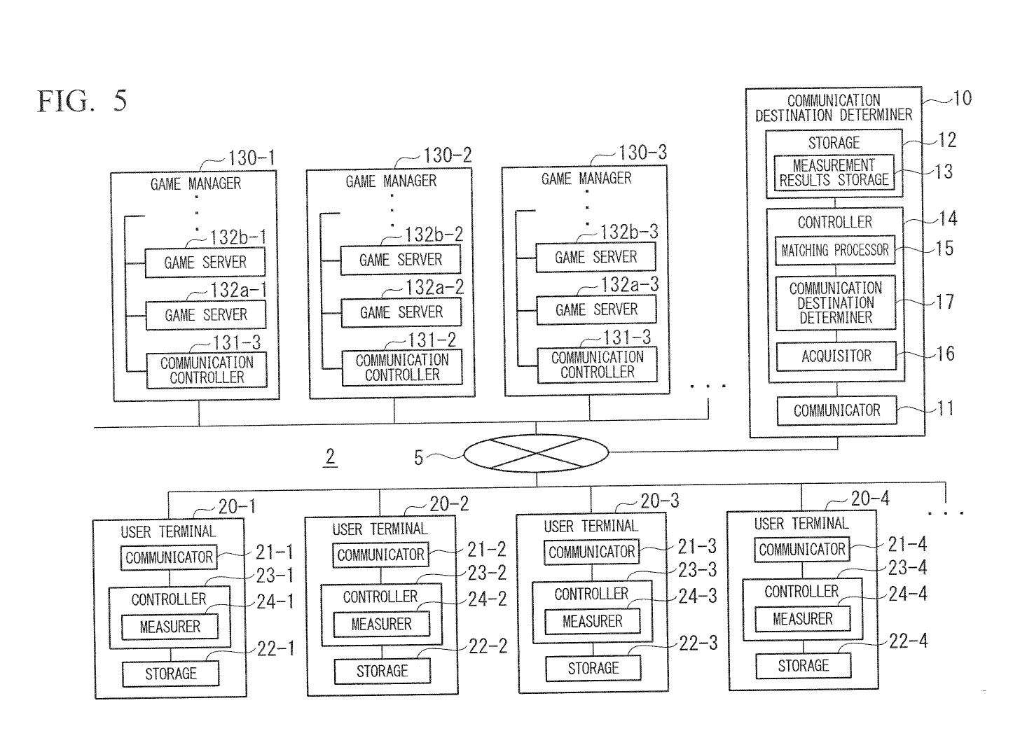

The third embodiment of the present invention will be described. Although the first embodiment has been described with the game manager 30 of a single computer, a game manager 30 can be configured by a plurality of computers in the game system 1 in which many user terminals 20 are connected. FIG. 5 is a block diagram showing an example of the configuration of a game system 2. The game system 2 of the present embodiment has a similar configuration as the game system 1 in the first embodiment, wherein the game manager 130 in the present embodiment corresponds to the game manager 30 in the first embodiment.

Because the plurality of game managers 130 has a similar configuration, they will be described as the game manager 130, omitting the suffixes -1, -2, and the like when not particularly distinguishing therebetween. The game manager 130 is a computer group providing a game service allowing a user terminal 20 to play a game via the network 5, and has a communication controller 131 and a plurality of game servers 132 (game server 132a, game server 132b, . . . ). In this case, because the game servers 132 have a similar configuration, they will be described as the game server 132, omitting the suffixes a, b, and the like, when not particularly distinguishing therebetween. Although two game servers 132 are shown in the drawing, an arbitrary number of game servers 132 may be provided in the game manager 130.

The communication controller 131 has a similar configuration as the communication controller 31 in the first embodiment.

The game server 132 has a function of virtualizing its own computer resources and launching and operating a virtual machine, on which a game program that performs computation processing for a game for a user terminal 20 is run. In this case, a game program for a plurality of associated user terminals 20 will cause progress through the multi-play game, with mutual communication within the game manager 30. The movie generated in the virtual machine on the game server 132 is distributed by streaming to the user terminals 20 by the communication controller 131.

Although, in the first to the third embodiments, the examples shown have been ones in which the required time measured base on a ping program was applied as the communication accessibility, with the communication accessibility being taken as greater, the smaller is the required time and lower, the larger is the required time, another value can be used as a measure of the speed and accessibility of communication between the user terminals 20 and the game manager 30. For example, the communication accessibility can be taken to be greater, the smaller is the packet loss rate in pinging, and smaller, the larger is the packet loss rate in pinging. Alternatively, for example, a large number of packets can be transmitted from the user terminal 20 to the game manager 30, and the transfer rate can be calculated based on the number of packets received by the game manager 30 per unit of time. In this case, the larger is the number of packets that could be transmitted in a unit of time, the greater is the communication accessibility, and the smaller is the number of packets that could be transmitted in a unit of time, the smaller is the communication accessibility. Alternatively, this type of transfer rate may be measured by a TTCP (test tcp) command, and an FTP (file transfer protocol) command can be used to transfer a file and the time required for transfer measured.

Although in the above-noted first to third embodiments the examples shown have been ones in which the acquisitor 16 transmits a communication accessibility measurement request to user terminals 20 associated by the matching processor 15, the communication accessibility can be measured beforehand by each user terminal 20 and, when a matching request is transmitted to the communication destination determiner 10, the results of the communication accessibility measurement can be transmitted simultaneously. Alternatively, the user terminals 20 can periodically measure the communication accessibility each prescribed time and transmit the measurement results to the communication destination determiner 10.

Also, in the configurations of the above-noted first to third embodiments, the various elements thereof can be distributed or concentrated in an arbitrary number of computers, in accordance with a cloud or network environment, the size in number of players, the types of games, the number of pieces of and specifications of hardware provided to configure the game system. For example, although in the above-noted first to the third embodiments the communication destination determiner 10 is configured to have a matching processor 15 performing matching processing, a matching server performing matching may be provided separately from the communication destination determiner 10.

Although in the above-noted first to third embodiments, the calculation of the determination reference value and the determination of the communication destination based on the above-described communication accessibility measurement results is performed by the communication destination determiner 10, this example of configuration is not a restriction and, for example, a configuration may be adopted wherein calculation of the determination reference value based on the communication result is done not by the communication destination determiner 10, but rather by the game manager 30 or another manager (not shown), and wherein the communication destination determiner 10 acquires the calculated determination reference value and determines the game manager 30 that is the communication destination.

A program for implementing the functionality of the processing units in the present embodiment may be stored in a computer-readable recording medium, a computer system being made to read out and execute the program stored in the recording medium, so as to perform the processing of the various units of the application system . The term “computer system” includes an operating system and hardware such as peripheral devices. The term “computer system” also includes a WWW system having a webpage-providing environment (or webpage-displaying environment). The term “computer-readable recording medium” refers to a removable medium such as a flexible disk, an optomagnetic disk, a ROM, a CD-ROM, or the like, or a storage device such as a hard disk drive or the like built into a computer system. Additionally, the term “computer-readable recording medium” encompasses one holding a program for a given period of time, such as a volatile memory (RAM) within a computer system serving as a server or client in the case in which a program is transmitted via a network such as the Internet or via a communication line such as a telephone line.

The above-noted program may be transferred from a computer system in which the program is stored in a storage apparatus to another computer system, either via a transfer medium, or by a transfer wave in a transfer medium. In this case, the term “transfer medium” transferring a program refers to a medium having a function of transferring information, such as a network (communication network) such as the Internet, or a communication circuit (communication line) such as a telephone line. The above-noted program may be for implementing a part of the above-described functionality. Additionally, it may be a so-called difference file (difference program) enabling a combination with a program that already has recorded the above-noted functionality in a computer system.

The systems and methods in the above-described embodiments may be deployed in part or in whole through a machine that executes computer software, software components, program codes, and/or instructions on one or more processors. The one or more processors may be part of a general-purpose computer, a server, a cloud server, a client, network infrastructure, mobile computing platform, stationary computing platform, or other computing platform. One or more processors may be any kind of computational or processing device or devices which are capable of executing program instructions, codes, binary instructions and the like. The one or more processors may be or include a signal processor, digital processor, embedded processor, microprocessor or any variants such as a co-processor, for example, math co-processor, graphic co-processor, communication co-processor and the like that may directly or indirectly facilitate execution of program codes or program instructions stored thereon. In addition, the one or more processors may enable execution of multiple programs, threads, and codes. The threads may be executed simultaneously to enhance the performance of the one or more processors and to facilitate simultaneous operations of the application. Program codes, program instructions and the like described herein may be implemented in one or more threads. The one or more processors may include memory that stores codes, instructions and programs as described herein. The processor may access a non-transitory processor-readable storage medium through an interface that may store codes, instructions and programs as described herein and elsewhere. The non-transitory processor-readable storage medium associated with the processor for storing programs, codes, program instructions or other type of instructions capable of being executed by the computing or processing device may include but may not be limited to one or more of a memory, hard disk, flash drive, RAM, ROM, CD-ROM, DVD, cache and the like.

It is apparent that the present invention is not limited to the above embodiments, but may be modified and changed without departing from the scope and spirit of the invention.

What is claimed is:

1. A communication destination determination apparatus comprising:
an acquisitor configured to acquire measurement results of accessibility of communication between each of a plurality of user terminals associated with each other and each of a plurality of game managers configured to communicate with each of the plurality of user terminals; and
a communication destination determiner configured to determine, based on the measurement results acquired by the acquisitor, and among the plurality of game managers, a target game manager as a communication destination to which the plurality of user terminals are to communicate,
wherein the acquisitor and the communication destination determiner are implemented by one or more processors.

2. The communication destination determination apparatus according to claim 1,
wherein the communication destination determiner is configured to calculate respective sums of the measurement results, for respective game managers, each sum being calculated from the measurement results of accessibility of communication between the plurality of user terminals and a respective one of the plurality of game managers,
wherein the communication destination determiner is configured to compare the respective sums with each other, and
wherein the communication destination determiner is configured to determine, based on a result of comparison among the respective sums, the target game manager as a communication destination to which the plurality of user terminals are to communicate.

3. The communication destination determination apparatus according to claim 1,
wherein the communication destination determiner is configured to weight the measurement results of accessibility of communication between each of the plurality of user terminals and each of the plurality of game managers,
wherein the communication destination determiner is configured to calculate respective weighted sums of the weighted measurement results, for respective game managers, each weighted sum being calculated from the weighted measurement results of accessibility of communication between the plurality of user terminals and a respective one of the plurality of game managers,
wherein the communication destination determiner is configured to compare the respective weighted sums with each other, and
wherein the communication destination determiner is configured to determine, based on a result of comparison among the respective weighted sums, the target game manager as a communication destination to which the plurality of user terminals are to communicate.

4. The communication destination determination apparatus according to claim 1,
wherein the acquisitor is configured to acquire, as the measurement result, a period of time from transmission by the user terminal of a packet to the game manager until the user terminal receives a response from the game manager,
wherein the communication destination determiner is configured to calculate respective sums of the periods of time, for respective game managers, each sum being calculated from the periods of time from transmissions by the plurality of user terminals of packets to a respective one of the plurality of game managers until each of the plurality of user terminals receives a response from the respective one of the plurality of game managers,
wherein the communication destination determiner is configured to compare the respective sums with each other,
wherein the communication destination determiner is configured to determine, based on a result of comparison among the respective sums, the target game manager as a communication destination having a smallest sum among the plurality of game managers having the respective sums.

5. The communication destination determination apparatus according to claim 1,
wherein the acquisitor is configured to acquire, as the measurement result, a period of time from transmission by the user terminal of a packet to the game manager until the user terminal receives a response from the game manager,
wherein the communication destination determiner is configured to weight each of the periods of time from transmissions by each of the plurality of user terminals of packets to each of the plurality of game managers until the each user terminal receives a response from the each game manager,
wherein the communication destination determiner is configured to calculate respective weighted sums of the weighted periods of time, for respective game managers, each sum being calculated from the weighted periods of time from transmissions by the plurality of user terminals of packets to a respective one of the plurality of game managers until each of the plurality of user terminals receives a response from the respective one of the plurality of game managers,
wherein the communication destination determiner is configured to compare the respective weighted sums with each other,
wherein the communication destination determiner is configured to determine, based on a result of comparison among the respective sums, the target game manager as a communication destination having a smallest weighted sum among the plurality of game managers having the respective weighted sums.

6. The communication destination determination apparatus according to claim 5,
wherein the communication destination determiner is configured to weight each of the periods of time by squaring the each period of time.

7. The communication destination determination apparatus according to claim 1,
wherein the communication destination determiner is configured to calculate respective determination reference values for respective ones of the plurality of game managers, from the measurement results acquired by the acquisitor, and
wherein the communication destination determiner is configured to determine, among the plurality of game managers, the target game manager as a communication destination with reference to the respective determination reference values.

8. A communication destination determination system comprising:
a plurality of user terminals associated with each other;
a plurality of game managers configured to communicate with each of the plurality of user terminals;
a measurer configured to measure an accessibility of communication between each of the plurality of user terminals and each of the plurality of game managers; and
a communication destination determiner configured to determine, based on the accessibility of communication measured by the measurer, and among the plurality of game managers, a target game manager as a communication destination to which the plurality of user terminals are to communicate,
wherein the game managers, the measurer, and the communication destination determiner are implemented by one or more processors.

9. A communication destination determination method comprising:
acquiring measurement results of accessibility of communication between each of a plurality of user terminals associated with each other and each of a plurality of game managers configured to communicate with each of the plurality of user terminals; and
determining, based on the measurement results acquired, and among the plurality of game managers, a target game manager as a communication destination to which the plurality of user terminals are to communicate,
wherein the acquiring process and the determining process are implemented by one or more processors.

10. A non-transitory computer readable storage medium that stores a computer program to be executed by a computer to perform communication destination determination method, the program comprising:
a code for acquiring measurement results of accessibility of communication between each of a plurality of user terminals associated with each other and each of a plurality of game managers configured to communicate with each of the plurality of user terminals; and
a code for determining, based on the measurement results acquired, and among the plurality of game managers, a target game manager as a communication destination to which the plurality of user terminals are to communicate.

11. A communication destination determination apparatus comprising:
a communication destination determiner configured to calculate respective determination reference values, for respective ones of a plurality of game managers configured to communicate with each of a plurality of user terminals associated with each other, from measurement results of accessibility of communication between each of the plurality of user terminals and each of the plurality of game managers, the communication destination determiner being configured to determine, among the plurality of game managers, a target game manager as a communication destination with reference to the respective determination reference values,
wherein the communication destination determiner is implemented by one or more processors.

12. A communication destination determination method comprising:
calculating respective determination reference values, for respective ones of a plurality of game managers configured to communicate with each of a plurality of user terminals associated with each other, from measurement results of accessibility of communication between each of the plurality of user terminals and each of the plurality of game managers; and
determining, among the plurality of game managers, a target game manager as a communication destination with reference to the respective determination reference values,
wherein the calculating process and the determining process are implemented by one or more processors.

13. A non-transitory computer readable storage medium that stores a computer program to be executed by a computer to perform communication destination determination method, the program comprising:
a code for calculating respective determination reference values, for respective ones of a plurality of game managers configured to communicate with each of a plurality of user terminals associated with each other, from measurement results of accessibility of communication between each of the plurality of user terminals and each of the plurality of game managers; and
a code for determining, among the plurality of game managers, a target game manager as a communication destination with reference to the respective determination reference values.
